(19) United States
(12) Patent Application Publication
(10) Pub. No.: US 2011/0186418 A1
(43) Pub. Date: Aug. 4, 2011

(54) PARTICULATE FILTER HAVING MINERAL FILTER MEDIA

(75) Inventor: Laurent Molins, Souppes Sur Loing (FR)

(73) Assignee: SAINT-GOBAIN QUARTZ S.A.S, Courbevoie (FR)

(21) Appl. No.: 13/003,784

(22) PCT Filed: Jul. 10, 2009
(86) PCT No.: PCT/FR2009/051393

§ 371 Date: Apr. 6, 2011

(30) Foreign Application Priority Data
Jul. 15, 2008 (FR) 0854805

(51) Int. Cl. B01D 53/75; B01D 46/30; B01D 46/42; B01D 53/86; B01J 8/02

(52) U.S. Cl. 204/157.3; 55/512; 55/383; 95/274; 422/211

(57) ABSTRACT

The invention relates to a particulate filter comprising a cartridge and a filter media placed in the cartridge in the prefiltering position, said filter media being essentially mineral. Thanks to the absence of any organic compound, the filter media generates no volatile organic compound. The filter media may also be of the type having a photocatalytic action.

The invention relates to the field of particulate filters.

Particulate filters comprise a filter media whose role is to retain the particulates with which an atmosphere is laden. Their purpose is to purify the atmosphere of premises of all kinds, for habitation or professional use, such as offices, workshops, factories, hangars, etc., with a concern for better preserving the health of the occupants thereof and/or to better protect an activity that cannot easily accommodate the presence of dust particles. To do this, the atmosphere to be purified is driven as a forced flow using a fan through a particulate filter.

A particulate filter comprises a cartridge (i.e. the case defining the outer shell of the filter) and a filter media. The first filter media (which may be the only one in the cartridge) along the path of the air coming from outside the filter is often called a “prefilter”, its role always being to retain the solid or liquid particulates suspended in the air. It is placed in the first position in the cartridge, i.e. it receives the ambient air coming from outside the filter directly, i.e. without the air passing through another filter media before it. Within the context of the present application, this first position relative to the incoming air is called the “prefiltering position”. The cartridge may comprise other filter media (along the path of the gas to be purified) behind this first filter media in the prefiltering position. The filter media for trapping the particulates (in the prefiltering position or behind it) may be one or more filter media such as those usually designated as G1, G2, G3, G4, F5, HEPA, ULPA. The cartridge may in fact have a succession of filter media, the selectivity of which increases in relation to the size of the particulates stopped. The one or more filter media may also be followed by a filter media having a photocatalytic action. The prefilter (or first filter media) is generally placed behind a mesh (generally made of metal) which is not considered as being a filter media. This mesh generally lets the light coming from outside the filter to pass directly to the prefilter.

Many types of filter media exist on the market. Until now, they consist of organic or mineral fibers bound by an organic binder. It has now been found that the organic matter contained in the filter media tends to be attacked by the oxidizing gas (or gases), such as ozone, contained in the air that passes through it. This attack (oxidation reaction) leads to the formation of VOCs (volatile organic compounds) which are relatively toxic, such as for example formaldehyde. The organic matter contained in a filter media of a filter is therefore a source of VOCs, more especially as the forced flow which travels through it continuously replenishes the oxidizing gas (such as ozone) in contact with it. The filter media is therefore a larger source of VOCs when the fan (or turbine) conveying the air through the filter is in operation than when it is not in use. In addition, by its nature, the area of the filter media is not inconsiderable, which is conducive to substantial attack by the oxidizing gas contained in the air. By solving one problem, i.e. the removal of particulates in the atmosphere, another problem is created through the formation of VOCs in the same atmosphere. When the filter cartridge also contains a filter having a photocatalytic action (behind the one or more filter media retaining the particulates along the path of the flowing gas), the role of which is specifically to remove the VOCs from the air entering the filter, it is particularly counter-productive to enrich the air with VOCs just before it passes over the filter having a photocatalytic action since the effectiveness of the latter could thereby be reduced owing to the greater amount of VOCs to be controlled.

The invention stems now from the idea of using, at least as prefilter, an entirely mineral filter media so as no longer to generate VOCs when the filter is operating. One excellent filter media according to the invention is a felt of silica fibers (silica often being called “quartz”, comprising at least 99% SiO₂ by weight) having no organic binder, such as the felt sold under the trade name Quartzel by Saint-Gobain Quartz. The process for manufacturing this felt produces a natural entanglement of the fibers, requiring no binder. Other filter media are conceivable, especially glass fiber woven fabrics and nonwovens provided that they have been stripped of the organic materials used to manufacture them, either as a possible size or as a binder. The binder may in particular have been of the sol-gel type. These woven fabrics and nonwovens may have been bound together by stitching or needling. In particular, a fibrous structure may be stripped of its organic materials by a heat treatment, which may for example take place at above 400° C.

The filter media placed in the prefiltering position is essentially mineral and contains less than 0.1% by weight of organic matter, or even less than 0.01% by weight of organic matter, or indeed even no organic matter (which is the case with Quartzel). Its LOI (loss on ignition) is less than 0.1%, or even less than 0.01%, indeed even zero. Its mass per unit area generally ranges from 5 to 400 g/m² and more generally from 10 to 300 g/m². The filter media in the prefiltering position may also have a photocatalytic action, in which case not only does it retain the particulates but it also eliminates the

VOCs contained in the air. It is known how to produce an essentially mineral photocatalytic coating—for this, the reader may for example refer to French patent application No. 07/57000 filed on Aug. 8, 2007. In general, the coating having a photocatalytic action contains titanium oxide. If the filter contains a filter media having a photocatalytic action, it then also contains the UV (UVA, UVB, UVC, visible UV) source needed to activate it (a UV lamp).

It will be recalled that loss on ignition may be determined in the following manner: prior dehydration at 110° C. (for example for 4 hours); calcination in air at 800° C. (for example for 4 hours); and measurement of the weight loss caused by the calcination (excluding dehydration).

Preferably, any filter media contained in the cartridge is essentially mineral and meets the same requirements (amount of organic matter and loss on ignition) as the filter media placed in the prefiltering position.

The invention also relates to a device comprising the particulate filter according to the invention and a fan or turbine for forcing the air to pass through the particulate filter. The invention also relates to the use of the device according to the invention for purifying the internal atmosphere of a building. In particular, the filter according to the invention may be incorporated into an air purifier, the operation of which involves UV radiation of type C, or one having a photocatalytic action. Dust-arresting filters of the prior art contain organic binding agents which undergo appreciable degradation. This degradation is due to the action of UVC radiation and of the hydroxyl radicals resulting from the photocatalytic reaction, possibly combined with the action of ozone. This degradation may generate by-products of the VOC type, especially of the aldehyde and formaldehyde type. The use of a mineral prefilter provides a solution to this problem. The invention also relates to the use of the filter according to the invention in an air purifier having a photocatalytic action (containing a material having a photocatalytic action when exposed to UVC, UVB, UVA or visible UV) or a UVC air purifier (containing no material having a photocatalytic action).

1. A particulate filter comprising a cartridge and a filter media placed in the cartridge in the prefiltering position, wherein the filter media is essentially mineral.

2. The filter as claimed in claim 1, wherein the filter media has a loss on ignition of less than 0.1% by weight.

3. The filter as claimed in claim 1, wherein the filter media has a loss on ignition of less than 0.01% by weight.

4. The filter as claimed in claim 1, wherein the filter media is a felt of mineral fibers comprising no organic binder.

5. The filter as claimed in claim 1, wherein the mineral is a silica fiber.

6. The filter as claimed in claim 1, wherein the filter media also has a photocatalytic action.

7. The particulate filter as claimed in claim 1, wherein the filter media is followed along the path of the gas by another filter media having a photocatalytic action.

8. The particulate filter as claimed in claim 1, wherein the mass per unit area of the filter media ranges from 5 to 400 g/m2.

9. A device comprising a particulate filter as claimed in claim 1 and a fan or turbine for forcing the air to pass through the particulate filter.

10. A method of purifying the internal atmosphere of a building comprising passing internal air through a device according to claim 9.

11. The method as claimed in claim 1, wherein the filter is in an air purifier having a UVC, UVB, UVA or visible UV photocatalytic action.

12. The method as claimed in claim 10, wherein the filter is in a UVC air purifier.

13. The particulate filter as claimed in claim 1, wherein the mass per unit area of the filter media ranges from 10 to 300 g/m².
